(19) United States
(12) Patent Application Publication
(10) Pub. No.: US 2005/0229915 A1
(43) Pub. Date: Oct. 20, 2005

(54) Apparatus for cutting concrete using abrasive cable

(76) Inventor: Jeffery R. VanGundy, Skidmore, MO (US)

Correspondence Address: ERICKSON & KLEYPAS, L.L.C., 800 W. 47TH STREET, SUITE 401, KANSAS CITY, MO, 64112, US

(21) Appl. No.: 10/824,088

(22) Filed: Apr. 14, 2004

(51) Int. Cl. B28D 1/04

(52) U.S. Cl. 125/21

(57) ABSTRACT

An apparatus for cutting large horizontal slabs of green or uncured concrete, such as roadways, with a single downward motion. The apparatus broadly comprises a cutting head including a cutting element, a drive pulley, an outboard pulley, and a foot structure; a drive motor; and a moveable support carriage. The cutting element is a closed loop of diamond wire entrained about the drive and outboard pulleys, with the drive pulley being driven by the drive motor. The foot structure includes a channel-shaped foot structure having two horizontally-extending flanges that function to minimizes spalling or chipping during cutting. The carriage movably supports the cutting head and the motor on inboard and outboard rolling elements, such as wheels or tracks, that allow for rolling movement over and along the concrete slab. The carriage also allows for lowering and raising the cutting element to engage and disengage the concrete slab during cutting.

### BACKGROUND OF THE INVENTION

1. Field of the Invention

The present invention relates to devices and apparatuses for cutting large horizontal concrete slabs. More particularly, the present invention relates to an apparatus for cutting joints in roadways using an abrasive cable such as diamond wire.

2. Description of the Related Art

It is often necessary or desirable to cut large slabs of concrete, such as, for example, to create transverse joints in roadways in order to control cracking due to expansion and contraction, settling, or other movement of the concrete slab. Once cut, these joints are filled with a sealing compound to prevent entry of water, oil, or other fluids that might otherwise adversely affect the integrity the concrete slab. A variety of prior art devices are known for making such cuts, all of which employ rotating abrasive disks as cutting elements.

Unfortunately, these prior art devices suffer from a number of problems and disadvantages including, for example, that they cannot be used in all states because of varying state specifications and procedures. Furthermore, prior art devices experience undesirable and sometimes unpredictable changes in operation, including variations in precision and performance, when operating during adverse weather conditions, particularly relatively hot or cold ambient temperatures, or when cutting concrete slabs containing certain aggregate mixes.

Additionally, prior art devices have relatively limited power and cutting ability and therefore have a relatively narrow window of opportunity for cutting concrete slabs during the curing process. The cuts must be made early in the curing process before the concrete slab becomes too hard to cut. This window does not always occur at the same time or have the same duration.

Prior art devices also require that the cutting element begin cutting at one side of the concrete slab and traverse to the other side. With a walk-behind prior art device, this requires the workman using the device to touch, walk upon, or otherwise disturb or track the uncured concrete slab along the cut line.

Additionally, prior art devices are dependent on the workman's senses for accuracy, and therefore rarely produce cuts of uniform straightness and depth. It is known in the prior art to create chalk lines on the surface of the concrete slabs for the workmen to follow when cutting, but creating these lines slows the cutting process, and the lines do not assist in establishing or determining cut depth. Relatedly, because the prior art devices use abrasive disks as cutting elements, the maximum depth that can be cut is, in each instance, limited by the radius of the disk.

Prior art devices are also prone to leaving a substantial amount of concrete dust debris or other debris within the cut, which must then, in a separate step, be removed prior to filling the joint with sealing material. If the debris is not adequately removed, particularly from the sides of the cut, then the sealing material may not bond.

It should be noted that, while it is known to use diamond wire to cut vertical concrete structures in applications where both sides of the concrete are accessible, such as, for example, to cut door openings in concrete walls, diamond wire has not been used as a cutting element to cut large horizontal slabs of concrete of the type used to form roads. Diamond wire generally comprises a steel wire or cable strung though beads onto which synthetic diamond material has been bonded. The beads are separated by spring spacers.

Accordingly, there is a need for an improved apparatus for cutting large horizontal concrete slabs.

### SUMMARY OF THE INVENTION

The present invention solves the above-described and other problems and disadvantages in the prior art by providing an improved apparatus for cutting large horizontal concrete slabs. More specifically, the apparatus of the present invention is broadly capable of cutting joints in green or uncured concrete slabs, such as, for example, roadways, with a single, downward motion. In a preferred embodiment, the apparatus broadly comprises a cutting head including a cutting element, a drive pulley, an outboard pulley, and a foot structure; a drive motor; and a moveable wheeled or tracked support carriage.

The cutting element is preferably a closed loop of diamond wire suitable for engaging the concrete slab and cutting a transverse groove thereinto. The drive and outboard pulleys drive and support the diamond wire, with the diamond wire being entrained thereabout. The pulleys are spaced apart a sufficient distance to allow for spanning and cutting an entire lane of roadway at once with a single downward motion.

The foot structure minimizes spalling or chipping of the concrete slab during cutting. This is accomplished by a channel-shaped foot having two horizontally-extending flanges which, during cutting, contact the surface of the concrete slab on each side of the cutting element. The foot structure retracts to maintain pressure on the surface of the concrete slab as the cutting element cuts into it.

The drive motor drives the drive pulley and the cutting element. The support carriage movably supports the cutting head and the motor on inboard legs and wheels and outboard legs and wheels that allow for rolling movement of the cutting head over and along the concrete slab while supporting the apparatus on the ground adjacent the concrete slab. The carriage also allows for lowering and raising the cutting element to engage and disengage the concrete slab during cutting.

Thus, it will be appreciated that the apparatus of the present invention provides a number of distinct advantages over the prior art, including, for example, that it works with all methods and procedures of cutting (e.g., early entry, dry green concrete, wet green concrete). Furthermore, the apparatus will work in any adverse weather conditions and temperatures and with any aggregate mix. Additionally, the apparatus has greater cutting ability to allow for greater flexibility with regard to when cuts can be made during the curing process. The apparatus also enables cutting to be performed without otherwise touching, walking upon, or disturbing the uncured concrete slab. Additionally, the apparatus automatically produces precise and accurate cuts that are both straight and uniformly deep, which, in turn, allows for easier and more efficient installation of joint-sealing material. Relatedly, the maximum depth of cut attainable by the apparatus is limited only by the degree of travel allowed for by the foot structure relative to the cutting element. The apparatus also operates to augur or push all concrete dust debris resulting from cutting out to the edges of the concrete slab, thereby providing, without additional cleaning steps, a cleaner surface to which the sealing material can bond. Thus, the apparatus of the present invention can result in substantial cost savings due to significant reductions in labor required to cut, clean, and seal large concrete slabs.

These and other important aspects of the present invention are described more fully below in the section titled DETAILED DESCRIPTION OF A PREFERRED EMBODIMENT.

### BRIEF DESCRIPTION OF THE DRAWINGS

FIG. 1 is an isometric view of a preferred embodiment of the apparatus of the present invention, wherein the apparatus is depicted in actual operation.

FIG. 2 is an isometric view of a cutting head component of the apparatus of FIG. 1.

FIG. 3 is an exploded, fragmentary, isometric view of certain subcomponents of the cutting head component of FIG. 2.

FIG. 4 is a sectional, fragmentary, isometric view of a portion of the apparatus of FIG. 1 immediately prior to beginning a cut.

FIG. 5 is a sectional, fragmentary, isometric view of the portion of the apparatus shown in FIG. 4 in the process of making the cut.

FIG. 6 is an isometric view of the finished cut which was begun in FIG. 4.

FIG. 7 is an enlarged, fragmentary, isometric view of a length of an abrasive cable in the form of diamond wire used as the preferred cutting element of the apparatus.

FIG. 8 is an enlarged and fragmentary cross-sectional view showing an intermediate pulley supporting the abrasive cable in a groove formed by the abrasive cable.

### DETAILED DESCRIPTION OF THE PREFERRED EMBODIMENTS

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. The drawings constitute a part of this specification and include exemplary embodiments of the present invention and illustrate various objects and features thereof. The drawings are not necessarily to scale, emphasis instead being placed upon clearly illustrating the principles of the invention.

Certain terminology will be used in the following description for convenience in reference only and will not be limiting. For example, the words “upwardly,” “downwardly,” “rightwardly,” and “leftwardly” will refer to directions in the drawings to which reference is made. The words “inwardly” and “outwardly” will refer to directions toward and away from, respectively, the geometric center of the embodiment being described and designated parts thereof. Said terminology will include the words specifically mentioned, derivatives thereof and words of a similar import.

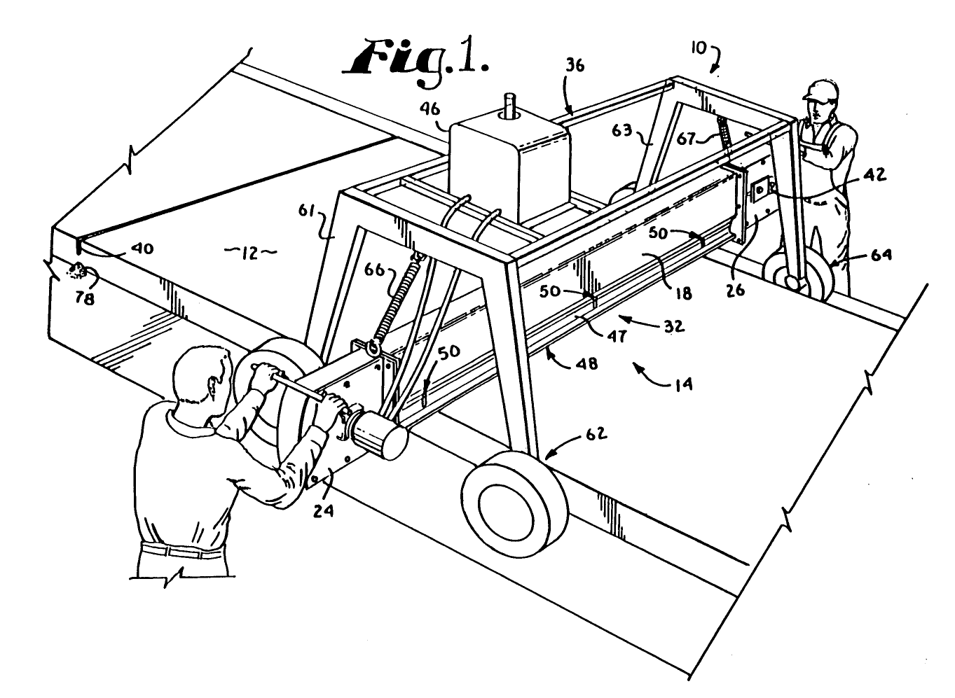

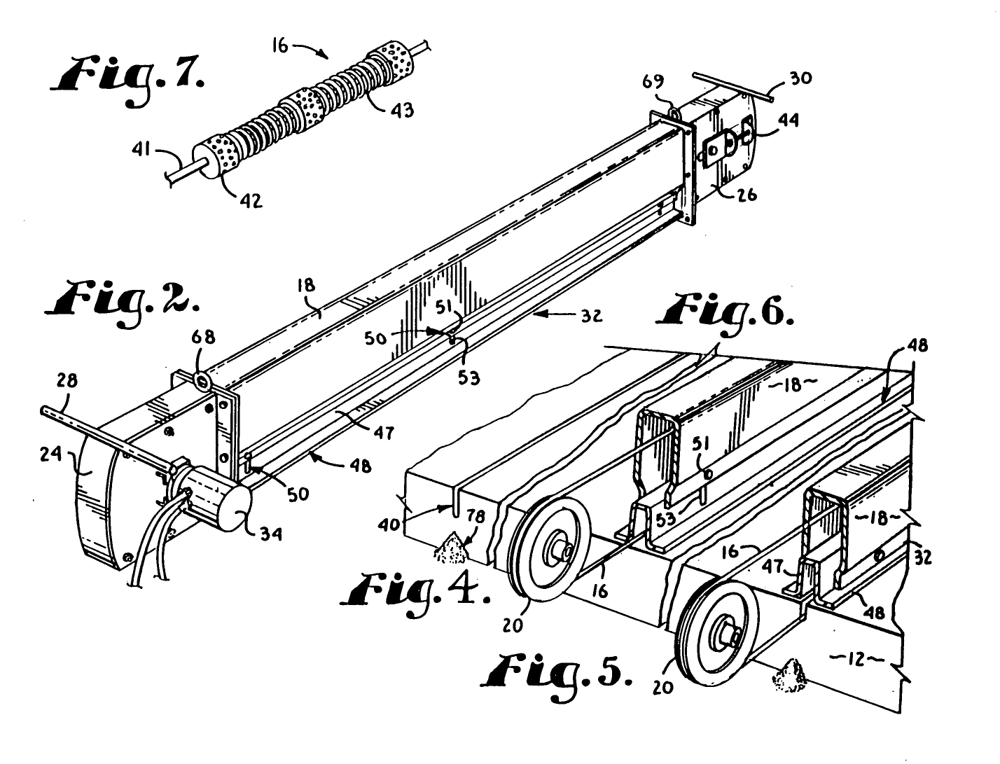

Referring to the figures, an apparatus 10 for cutting concrete is hereafter described and disclosed as being constructed in accordance with a preferred embodiment of the present invention. The apparatus 10 is broadly capable of cutting joints in green or uncured horizontal concrete slabs 12, such as, for example, roadways, with a single, downward motion. Referring particularly to FIGS. 1-3, the apparatus 10 broadly comprises a cutting head 14 including a cutting element 16, a guard 18, a drive pulley 20, an outboard pulley 22, a drive pulley enclosure 24, an outboard pulley enclosure 26, an inboard handle 28, an outboard handle 30, and a foot structure 32; a drive motor 34 having a drive shaft 35; and a movable support carriage 36.

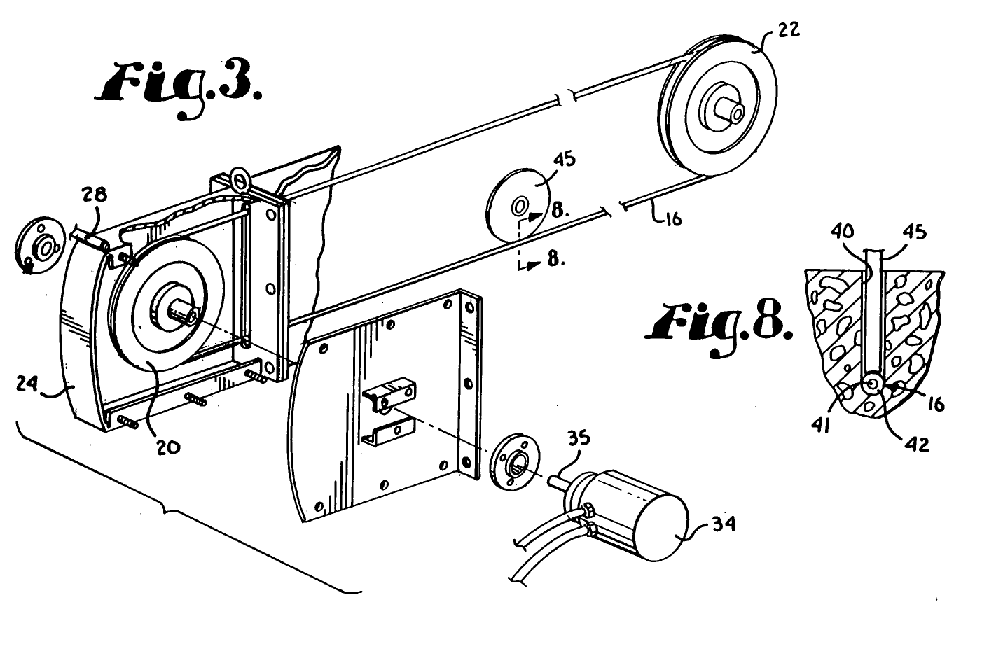

The cutting element 16 is adapted and operable to engage the concrete slab 12 and cut a transverse groove 40 thereinto (as shown in FIGS. 4-6). The cutting element 16 is preferably a closed loop of abrasive cable such as diamond wire. As shown in FIG. 7, diamond wire generally comprises a steel cable 41 strung through abrasive beads 42 onto which has been bonded synthetic diamond material. The beads 42 are separated from one another by spring spacers 43 strung onto the steel cable between the beads 42. Diamond is available from entities such as Trentec, Inc. at www.trentec.com. It is to be understood, however, that other types of flexible abrasive cable could be used in place of diamond wire as the cutting element 16. In addition to the diamond wire described herein, the term “cable” as used herein, would include flexible chains, wires and ropes of both metallic and non-metallic materials.

The guard 18 is adapted and operable to prevent items, objects, or body parts from accidently contacting the cutting element 16 while the cutting element 16 is moving. Thus, at least an upper portion of the cutting element 16 moves substantially within the confines defined by the guard 18 during cutting. The guard 18 may be constructed of any suitable material, including, for example, solid or mesh materials, or any combination thereof.

The drive and outboard pulleys 20,22 drive and support the cutting element 16, with the cutting element 16 being entrained thereabout. The pulleys 20,22 are spaced apart a sufficient distance to allow for spanning and cutting the entire concrete slab 12 (e.g., an entire lane or multiple adjacent lanes of a roadway) with the cutting element 16 at once, with a single downward motion. The outboard pulley 22 is adjustably mounted to the outboard pulley enclosure 26 by adjustment mechanism 44 that allows for adjusting the tension on the cutting element 16 by varying the spacing between the drive pulley 20 and outboard pulley 22. Additionally, one or more intermediate pulleys 45 may be included, as needed or desired, located between the drive and outboard pulleys 20,22 in order to provide further support for the cutting element 16.

The drive pulley 20 is powered or driven by the hydraulic motor 34 which is coupled directly to a shaft of pulley 20. Pressurized hydraulic fluid is supplied to the hydraulic motor 34 from an hydraulic pump which is powered by a gasoline engine, both of which are mounted on the carriage 36 within engine housing 46, which also contains an hydraulic fluid reservoir.

The drive pulley enclosure 24 and the outboard pulley enclosure 26 are adapted and operable to prevent items, objects, or body parts from accidently contacting the drive and outboard pulleys 20,22, respectively, while the pulleys 20,22 are moving.

The inboard handle 28 and outboard handle 30 are adapted and operable to allow operators of the apparatus 10 to both facilitate moving the apparatus 10 into position for cutting and to facilitate lowering and raising the cutting head 14 during cutting. As shown in FIG. 1, it is contemplated that two operators will operate the apparatus 10, with a first operator being located at the inboard end and the second operator being located at the outboard end. The inboard handle 28 may be connected to the cutting head 14 at its inboard end in an appropriate location, such as, for example, at the drive pulley enclosure 24. Similarly, the outboard handle 30 may be connected to the cutting head 14 at its outboard end in an appropriate location, such as, for example, at the outboard pulley enclosure 26.

The foot structure 32 is adapted and operable to minimize or prevent spalling or chipping of the concrete slab 12 during cutting. The foot structure 32 presents a channel-shaped foot 47 having two horizontally-extending flanges 48 which, during cutting, contact the surface of the concrete slab 12 on each side of the cutting element 16. The foot structure 32 retracts into the guard 18 of the cutting head 14 and maintains pressure on the surface of the concrete slab 12 as the cutting element 16 cuts into it.

One or more travel stops 50 may be provided, as needed or desired, to limit the retraction of the foot structure 32 into the guard 18, thereby automatically defining the maximum depth of cut and ensuring uniformity. The travel stops 50 shown comprise pins 51 extending outward from the opposite sidewalls of the foot structure 32 and through aligned slots 53 in the opposite sidewalls of guard 18. Alternatively, or in addition, stops may be formed by running bolts through or extending a fixed structure between the opposite sidewalls of guard 18 at a uniform selected height above the top of the foot structure 32 to limit the depth of insertion of foot 32 into guard 18.

The foot structure 32 may rely entirely upon its own weight to provide the desired degree of pressure, or, alternatively, one or more springs or other resistance mechanisms may be used. The contact between the flanges 48 and the concrete slab 12 prevents the green or uncured concrete from spalling or chipping during cutting.

The drive motor 34 is adapted and operable to drive the drive pulley 20 and the cutting element 16. The motor 34 may be hydraulic, electric, or mechanical in nature, as desired.

The movable support carriage 36 is adapted and operable to movably support the cutting head 14 over the concrete slab 12 and in position for cutting. The carriage 36 may also support the motor 34. The carriage 36 includes inboard legs 61 and rolling elements 62 (such as tracks or wheels) and outboard legs 63 and rolling elements 64 that allow for rolling movement of the cutting head 14 over and along the concrete slab 12. More specifically, when properly positioned for operation, the inboard rolling elements 62 are supported on the ground adjacent and outward from a near side of the concrete slab 12 and the outboard rolling elements 64 are supported on the ground adjacent and outward from an opposite, far side of the concrete slab 12, such that the entire apparatus 10 straddles the concrete slab 12 and the cutting element 16 is located directly over the concrete slab 12 and spans its entire width.

The cutting head 14 is connected to the carriage 36 by connection means which permits lowering and raising of the cutting head 14 to engage and disengage the concrete slab 12 during cutting. The connection means shown comprises springs 66 and 67. The springs 66 and 67 are connected at one end to the carriage 36 proximate legs 61 and 63 respectively and at opposite ends to eyelets 68 and 69 mounted on the cutting head 14 near its respective ends and inboard of handles 28 and 30. It is foreseen that other connection means which permit lowering and raising of the cutting head 14 may be utilized as an alternative or in addition to the springs 66 and 67. For example, a mechanical linkage could be utilized alone or in combination with the springs 66 and 67 to facilitate lowering and raising of the cutting head 14. Alternatively, pneumatic, hydraulic or mechanical actuators could be utilized to automatically lower and raise the cutting head without the need for manual intervention.

In exemplary use and operation, referring particularly to FIGS. 4-6, the apparatus 10 functions as follows. The apparatus 10 is first properly positioned for cutting, with inboard wheels 52 located adjacent the near side of the concrete slab 12 and outboard wheels 54 located adjacent the opposite, far side of the concrete slab 12, such that the entire apparatus 10 straddles the concrete slab 12. Once so positioned, the cutting element 16 is located directly over the concrete slab 12 and spans its entire width. The operators then activate drive motor 34, causing the drive pulley 20 to begin rotating which, in turn causes the cutting element 16 and the outboard pulley 22 to rotate. It is to be understood that valves (not shown) may be positioned between the hydraulic pump and the hydraulic motor 34, to permit an operator to selectively control the flow of hydraulic fluid to the hydraulic motor 34 to permit the operator to selectively rotate and stop the drive pulley 20 and attached cutting element 16 as desired and without having to start and stop the gasoline engine at the same time.

When ready to cut, the operators grip the inboard and outboard handles 28,30 and lower the cutting head 14 until the horizontally-extending flanges 48 of the channel-shaped foot 47 of the foot structure 32 contact the surface of the concrete slab 12 and the cutting element 16 engages the concrete slab 12. The pressure provided by the flanges 48 on the surface of the concrete slab 12 functions to avoid or substantially prevent spalling and chipping of the concrete during cutting. Thereafter, as the cutting element 16 cuts deeper into the concrete slab 12, the foot structure 32 retracts into the cutting head 14 in such a manner as to maintain a substantially constant pressure on the surface of the concrete slab 12. As generally shown in FIG. 5, the cutting element 16 effectively augurs or pushes all concrete dust debris 78 and other debris resulting from cutting out to the edges of the concrete slab 12, thereby facilitating post-cut clean-up.

When the desired depth of cut is reached, the operators lift upward on the inboard and outboard handles 28,30 to raise the cutting head 14, thereby disengaging the cutting element 16 from the concrete slab 12 and lifting the cutting element 16 out of the groove cut therein. The carriage 36 is then rolled a desired distance relative to the concrete slab 12 into position for another cut at a second location, and the process is repeated. The process may then be repeated at selected intervals along the entire length of the roadway making cuts at each location.

From the preceding discussion, will be appreciated that the apparatus 10 of the present invention provides a number of distinct advantages over the prior art, including, for example, that it works with all methods and procedures of cutting (e.g., early entry, dry green concrete, wet green concrete). By contrast, prior art devices cannot be used in all states because of varying state specifications and procedures.

Furthermore, the apparatus 10 will work in any adverse weather conditions and temperatures and with any aggregate mix. By contrast, prior art devices will experience changes in operation, including variations in precision and performance, when operating in adverse weather conditions, particularly relatively hot or cold ambient temperatures, or when cutting concrete slabs containing certain aggregate mixes.

Additionally, the apparatus 10 has greater cutting ability to allow for greater flexibility with regard to when cuts can be made during the curing process. By contrast, prior art devices have substantially less power and cutting ability and therefore have a narrower window of opportunity, and this window does not always occur at the same time or have the same duration. The apparatus 10 of the present invention is therefore less sensitive to this window than the prior art devices.

The apparatus 10 also enables cutting to be performed without otherwise touching, walking upon, or disturbing the uncured concrete slab 12. More specifically, the carriage 36 straddles, rather than rides upon, the concrete slab 12 to position the cutting head 14 for cutting. This is not possible with walk-behind prior art devices that require the workmen using the devices to walk upon the concrete slab along the cut line.

Additionally, the apparatus 10 automatically produces precise and accurate cuts 40 that are both straight and uniformly deep, which, in turn, allows for easier and more efficient installation of joint-sealing material. This is not possible with hand-held prior art devices that produce cuts whose straightness and depth are dependent upon the workmen's senses and therefore seldom straight or uniformly deep. Chalk lines can be created to assist workers using prior art devices to cut straighter lines, but creating these lines requires additional time, and the lines are of no help in establishing or determining cut depth. Relatedly, because the prior art devices use abrasive disks as cutting elements, the maximum depth that can be cut is; in each instance, limited by the radius of the disk. By contrast, the maximum depth of cut attainable by the apparatus 10 of the present invention is limited only by the degree of travel allowed for by the foot structure 32 relative to the cutting element 16.

The apparatus 10 also operates to augur or push all concrete dust debris 58 or other debris resulting from cutting out to the edges of the concrete slab 12. Prior art devices using abrasive disks as cutting elements leave a substantial amount of debris within the cut, which must then, in a separate step, be removed prior to filling the joint with sealing material. If the debris is not adequately removed, particularly from the sides of the cut, then the sealing material may not bond.

Thus, the apparatus 10 of the present invention can result in substantial cost savings due to significantly reductions in labor required to cut, clean, and seal large concrete slabs 12.

It is to be understood that while certain forms of the present invention have been illustrated and described herein, it is not to be limited to the specific forms or arrangement of parts described and shown. For example, the apparatus could include a drive assembly for driving the rolling elements 61 and 62 and propelling the carriage 36 along the surface into which grooves are to be cut. An operator's seat could be incorporated into the carriage 36 with controls for engaging and disengaging the drive motor 34 and the rolling elements 61 and 62

1. An apparatus for cutting a concrete slab, said apparatus comprising:
a) a cutting head including:
i) a cutting element;
ii) a drive pulley and an outboard pulley about which said cutting element is entrained, wherein said drive pulley and said outboard pulley are spaced apart a sufficient distance such that said cutting element spans the concrete slab; and
iii) a foot structure adapted to minimize damage to the concrete slab during cutting by exerting pressure on a surface of the concrete slab adjacent said cutting element during cutting; and
b) a drive motor adapted to drive said drive pulley and said cutting element.

2. The apparatus as set forth in claim 1, wherein said cutting element is a closed loop of flexible abrasive cable.

3. The apparatus as set forth in claim 3, wherein said flexible abrasive cable is diamond wire including a steel cable strung through a plurality of beads onto which is bonded synthetic diamond material.

4. The apparatus as set forth in claim 1, wherein said foot structure includes a channel-shaped foot having two horizontally-extending flanges which, during cutting, exert pressure against the surface of the concrete slab adjacent said cutting element.

5. The apparatus as set forth in claim 1, wherein said foot structure retracts in order to maintain pressure on the surface of the concrete slab as said cutting element cuts.

6. The apparatus as set forth in claim 1, wherein said drive motor is a hydraulic motor.

7. The apparatus as set forth in claim 1, further including a guard substantially enclosing at least an upper portion of said cutting element and adapted to prevent accidental contact therewith.

8. The apparatus as set forth in claim 1, further including:
a) a drive pulley enclosure substantially enclosing said drive pulley and adapted to prevent accidental contact therewith; and
b) an outboard pulley enclosure substantially enclosing said outboard pulley and adapted to prevent accidental contact therewith.

9. The apparatus as set forth in claim 1, further including an inboard handle adapted to facilitate lowering and raising said cutting head during cutting.

10. The apparatus as set forth in claim 9, further including an outboard handle adapted to further facilitate lowering and raising said cutting head during cutting.

11. The apparatus as set forth in claim 1, and further including a moveable carriage adapted to support said cutting head and allow for lowering and raising said cutting element during cutting, wherein said moveable carriage includes a plurality of rolling elements that allow for rolling said apparatus into position for cutting.

12. The apparatus as set forth in claim 11, wherein said plurality of rolling elements of said moveable carriage include an inboard rolling element and an outboard rolling element located such that, when said apparatus is positioned for cutting, said inboard rolling element is located adjacent a first side of the concrete slab and said outboard rolling element is located adjacent a second side of the concrete slab, such that said apparatus straddles the concrete slab.

13. An apparatus for cutting a groove in a curing concrete slab with a downward motion, said apparatus comprising:
a) a cutting head including:
i) a cutting element, wherein said cutting element is a closed loop of flexible abrasive cable;
ii) a drive pulley and an outboard pulley about which said cutting element is entrained, wherein said drive pulley and said outboard pulley are spaced apart a sufficient distance such that said cutting element spans the curing concrete slab;
b) a drive motor adapted to drive said drive pulley and, in so doing, drive said cutting element; and
c) a moveable carriage adapted to movably support said cutting head over the curing concrete slab, said moveable carriage including an inboard rolling element and an outboard rolling element that allow for rolling movement of said apparatus.

14. The apparatus as set forth in claim 13, wherein said flexible abrasive cable is diamond wire including a steel cable strung through beads onto which has been bonded synthetic diamond material.

15. The apparatus as set forth in claim 13, wherein said drive motor is a hydraulic motor.

16. The apparatus as set forth in claim 13, wherein said inboard and outboard rolling elements are located such that, when said apparatus is positioned for cutting, said inboard rolling element is located adjacent a near side of the curing concrete slab and said outboard rolling element is located adjacent an opposite, far side of the curing concrete slab, such that the entirety of said apparatus straddles the curing concrete slab.

17. The apparatus as set forth in claim 13, wherein said moveable carriage is adapted to allow for lowering and raising said cutting element during cutting.

18. The apparatus as set forth in claim 13, further including a guard substantially enclosing at least an upper portion of said cutting element and adapted to prevent accidental contact therewith.

19. The apparatus as set forth in claim 13, further including:
a) a drive pulley enclosure substantially enclosing said drive pulley and adapted to prevent accidental contact therewith; and
b) an outboard pulley enclosure substantially enclosing said outboard pulley and adapted to prevent accidental contact therewith.

20. The apparatus as set forth in claim 13, further including inboard and outboard handles connected to said cutting head and adapted to facilitate lowering and raising said cutting head during cutting.

21. The apparatus as set forth in claim 13, further including a foot structure adapted to minimize damage to the curing concrete slab during cutting, wherein said foot structure includes a channel-shaped foot having two horizontally-extending flanges which, during cutting, exert pressure against a surface of the curing concrete slab adjacent said cutting element;

22. The apparatus as set forth in claim 21, wherein said foot structure retracts in order to maintain pressure on the surface of the curing concrete slab as said cutting element cuts.

23. An apparatus for cutting a transverse groove in a curing horizontal concrete slab with a single downward motion, said apparatus comprising:
a) a cutting head including:
i) a cutting element, wherein said cutting element is a closed loop of steel cable strung through beads onto which has been bonded synthetic diamond material;
ii) a guard substantially enclosing at least an upper portion of said cutting element and adapted to prevent accidental contact therewith;
iii) a drive pulley and an outboard pulley about which said cutting element is entrained, wherein said drive pulley and said outboard pulley are spaced apart a sufficient distance such that said cutting element spans the curing horizontal concrete slab;
iv) a drive pulley enclosure substantially enclosing said drive pulley and adapted to prevent accidental contact therewith;
v) an outboard pulley enclosure substantially enclosing said outboard pulley and adapted to prevent accidental contact therewith;
vi) an inboard handle adapted to facilitate moving said apparatus into position for cutting and to facilitate lowering and raising said cutting head during cutting;
vii) an outboard handle adapted to further facilitate moving said apparatus into position for cutting and to further facilitate lowering and raising said cutting head during cutting, and
viii) a foot structure adapted to minimize damage to the curing horizontal concrete slab during cutting, wherein said foot structure includes a channel-shaped foot having two horizontally-extending flanges which, during cutting, exert pressure against a surface of the curing horizontal concrete slab adjacent said cutting element, and said foot structure retracts in order to maintain pressure on the surface of the curing horizontal concrete slab as said cutting element cuts;
b) a hydraulic drive motor adapted to drive said drive pulley and, in so doing, drive said cutting element; and
c) a moveable carriage adapted to movably support said cutting head over the curing horizontal concrete slab, said moveable carriage including an inboard rolling element and an outboard rolling element that allow for rolling movement of said apparatus, wherein, when said apparatus is positioned for cutting, said inboard rolling element is located adjacent a first side of the curing horizontal concrete slab and said outboard rolling element is are located adjacent an opposite, second side of the curing horizontal concrete slab, such that the entirety of said apparatus straddles the curing horizontal concrete slab, and said moveable carriage allowing for lowering and raising said cutting element during cutting.

24. A method of cutting transverse slots in a first face of a slab of concrete having a second face in contact with the ground, said method comprising the steps of:
a) positioning a span of a continuous abrasive cable to extend entirely across the slab at a first location;
b) selectively rotating said continuous abrasive cable;
c) lowering said span of said continuous abrasive cable into contact with the first face of the slab at said first location while said continuous abrasive cable is rotating such that said span of said continuous abrasive cable rotates across said slab and cuts a first groove into the slab across the entire width of the slab at said first location in a first cutting step;
d) raising said span of said continuous abrasive cable out of said first groove in a raising step;
e) moving said continuous abrasive cable to position said span of said continuous abrasive cable to extend across the slab at a second location in a moving step;
f) lowering said span of continuous abrasive cable into contact with the first face of the slab at said second location while said continuous abrasive cable is rotating such that said rotating continuous abrasive cable cuts a second groove into the slab across the entire width of the slab at said second location in a second cutting step.

25. The method as in claim 24 and further including the step of supporting the first face of the slab on opposite sides of said span of said continuous abrasive cable while said continuous abrasive cable is cutting into the slab.

26. The method as in claim 24 wherein said continuous abrasive cable is diamond wire including a steel cable strung through a plurality of beads onto which is bonded synthetic diamond material.

27. The method as in claim 24 wherein said raising step, said moving step and said second cutting step are repeated a selected number of times at selected intervals along the length of the concrete slab.

28. The method as in claim 24 wherein said concrete slab comprises a roadway.
